(19) United States
(12) Patent Application Publication
(10) Pub. No.: US 2004/0202750 A1
(43) Pub. Date: Oct. 14, 2004

(54) Easy-open chub package with heat-sealed ends

(76) Inventor: Robert Thor Versluys, Florence, SC (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/411,710

(22) Filed: Apr. 10, 2003

(51) Int. Cl. C12C 1/027

(52) U.S. Cl. 426/106

(57) ABSTRACT

An improved chub package is provided which includes a tubular casing formed from a flat flexible film. The ends of the casing are heat sealed into a flattened fin seal. An arcuate slot is formed in at least one heat sealed end which assists in opening the package by providing a mechanism for tearing open the package, while also providing a convenient handle for carrying or hanging the package.

### FIELD OF INVENTION

The present invention relates to a tubular container for food products and the like. More particularly, the present invention relates to an easy-opening chub package with heat-sealed ends.

### BACKGROUND OF THE INVENTION

Food products such as sausages and cookie dough are often packaged in tubular casings. The packages are typically made from a thin, pliable material which is closed off at its opposite ends by metal bands or clips. Such packages are known in the industry as “chub” packages. Chub packages are generally formed by wrapping a continuous web of thin, heat-sealable material into a tube so that the side edges overlap, and then heat-sealing the overlapping edges to form a seam. The tubular casing is then filled with a desired amount of a food product, after which the tube casing is tied off or clamped on either side of the food product and the package is severed from the remainder of the casing.

To open the package, the ends of the casing must be cut away and the casing itself must be cut open to expose the food product. Alternatively, the casing may be punctured by a sharp object and the contents of the package extruded through the pierced wall by squeezing the package.

The process involved in opening existing chub packages is cumbersome and requires the use of sharp implements, such as knives and scissors, which can result in damage to the food product. Furthermore, it is not uncommon for some existing chub packages to trap a small amount of the food product in the outer bunched ends where it is tied or clamped shut. The trapped food is susceptible to bacterial or other types of contamination.

Also, existing chub packages typically require the addition of a hanger in order to display the package on a hanging store display. The addition of the hanger increases the overall cost of the product.

U.S. Pat. No. 5,074,822 to Stanley discloses one method for forming a chub package. The disclosed method requires the formation of a plurality of longitudinal folds in one end of the casing to seal the package. Another conventional chub package is disclosed in U.S. Pat. No. 3,419,206 to Omori.

In that patent, the chub package is formed with an opening tear strip partially heat sealed into the casing material. However, the ends of Omori are still clamped, this making release of the product difficult.

A need exists for an improved easy-opening chub package for food products.

### SUMMARY OF THE INVENTION

Accordingly, a general object of the present invention is to provide a tubular food casing or a chub package that does not require implements to open. The package incorporates a tear strip for providing an easy-opening package suitable for products currently sold in conventional chub packages, such as cookie dough, sausage, polenta and the like. It is also an object of the present invention to provide a chub package wherein the ends are hermetically sealed rather than tied or clamped. It is a further object of the present invention to provide a chub package that does not require a separate hanger for displaying the package on a hanging display.

In accordance with one aspect of the present invention, an improved chub package is provided which includes a tubular casing formed from a flat pliable film. The film is wrapped into a tubular shape with the edges overlapping one another. The ends of the casing are heat sealed, instead of gathered by a sealing band as in conventional packages. The heat seal can be tailored to maximize the packaging of the food product. For example, the heat seal can be applied so as to conform to the shape of the product to provide good pack formation and pressure distribution. The heat sealed end further incorporates an arcuate slot which facilitates opening of the package while providing a convenient handle for carrying, or storing the package.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention.

Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a front view of a package according to one embodiment of the invention.

FIG. 2 is a front view of the package of FIG. 1 in a partially opened state.

FIG. 3 is an isometric view of the package of FIG. 2 in the partially opened state.

FIG. 3A is an enlarged view of section 3A in FIG. 3 illustrating the tear open feature of the present invention.

### DETAILED DESCRIPTION OF THE DRAWINGS

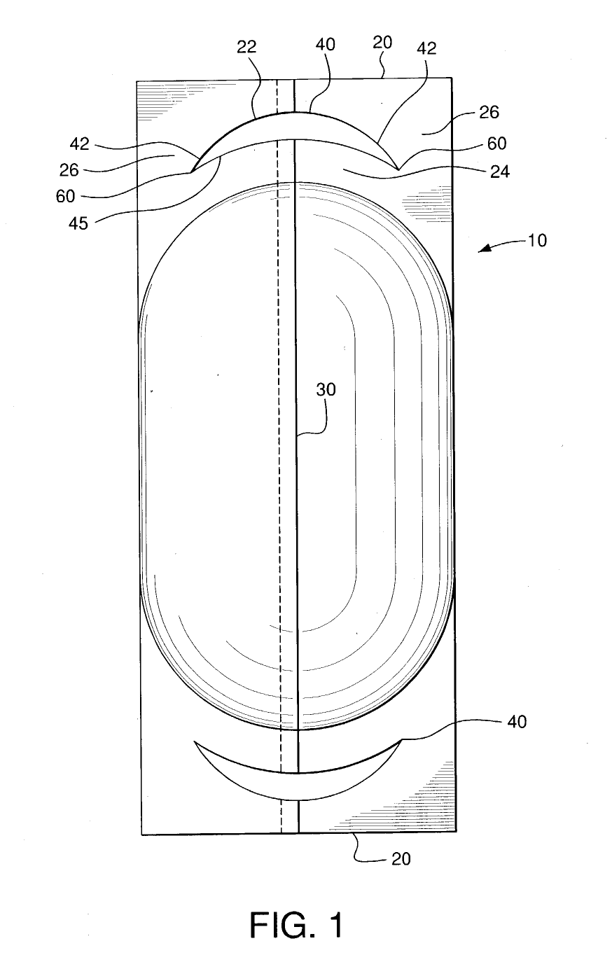

Referring now to the drawings, wherein like numerals indicate like elements, FIGS. 1-3 and 3A illustrate a chub package, which is generally denoted by the numeral 10. The package 10 includes a casing or outer layer 12 which is made from a flexible film material, such as a single or multi-ply conventional chub film material. In one preferred embodiment, the material selected is a multi-ply, heat-sealable film material, such as a laminate of polyethylene/oriented nylon/polypropylene or a laminate of polypropylene/oriented polyethylene with a barrier layer of polyvinyl chloride (PVC). Those skilled in the art would be readily capable of selecting other suitable film materials for use in the present invention in light of the teachings provided herein. The film material preferably has a thickness of approximately 2 to 3 mils. This thickness permits the film to be formed into the desired packaging shape, while permitting easy opening as will be described in more detail below. Of course, it should be readily apparent that other material thicknesses can be used in the present invention.

In its finished form, the casing 12 of the packaging is in a substantially tubular or cylindrical shape. The cylindrical shape of the casing is preferably formed by overlapping the edges of the film material and then sealing the overlapped edges to one another to form a lap seal 30. The sealing of the overlapping edges is preferably through a heat seal, although other methods of sealing may be used, such as adhesive sealing. Also, while a lap seal 30 is the preferred method for forming the casing 12, other methods may be used for forming the tubular casing 12, and are well known to those skilled in the art.

The tubular casing 12 includes upper and lower ends which are closed off by heat sealing the casing material to form flattened fin seals 20. The flattening and sealing of the casing 12 stiffens the ends of the package 10, adding significant rigidity to the packaging. In order to maximize the protection of the food products contained within the packaging 10, the heat seal of the ends 20 is preferably curved or arcuate adjacent to the food product. As such, the packaging tends to conform to or compact the food product contained within the package 10. This curved sealing of the ends 20 provides greater protection for the food product by minimizing movement of the product within the package, reducing the amount of air that may be trapped within the package (which could lead to premature spoilage), and providing even pressure distribution across the end of the food product.

The upper and/or lower fin seals 20 include at least one slotted opening 40 which is formed through the film material. The opening 40 is preferably formed by die cutting the casing 12. The slotted opening 40 in the package 10 of the present invention serves several functions. First, the slotted opening 40 provides a convenient display hanging mechanism for storing the product. To this end, the rigidity provided by the sealing of the ends 20, as well as the lap seal 30 (which, as shown, preferably extends through the center of each heat sealed end) permits the package 10 to be hung by the slot 40 without tearing.

Second, the slotted opening 40 also functions as a convenient handle for carrying the package. Chub packages are relatively bulky and, thus, could be difficult to hold. The slotted opening 40 facilitates grasping by a user.

Lastly, the slotted opening 40 also provides a mechanism for easily opening the package. As described above, prior art packages were generally very difficult to open, typically requiring the use of sharp implements to cut through the casing. A package design according to the present invention would, ordinarily be just as difficult to open, especially since it is designed to conform relatively tightly to the food product contained within it. To facilitate opening of the package, the present invention incorporates the slotted opening 40 as a preferred mechanism for tearing through the film casing 12. As shown in the figures, at least one fin seal 20 includes a first portion 22 located above the slotted opening 40 and a second portion 24 located below the slotted opening 40. The first and second portions 22, 24 are connected to one another on the sides by bridge sections 26 of slotted opening 40.

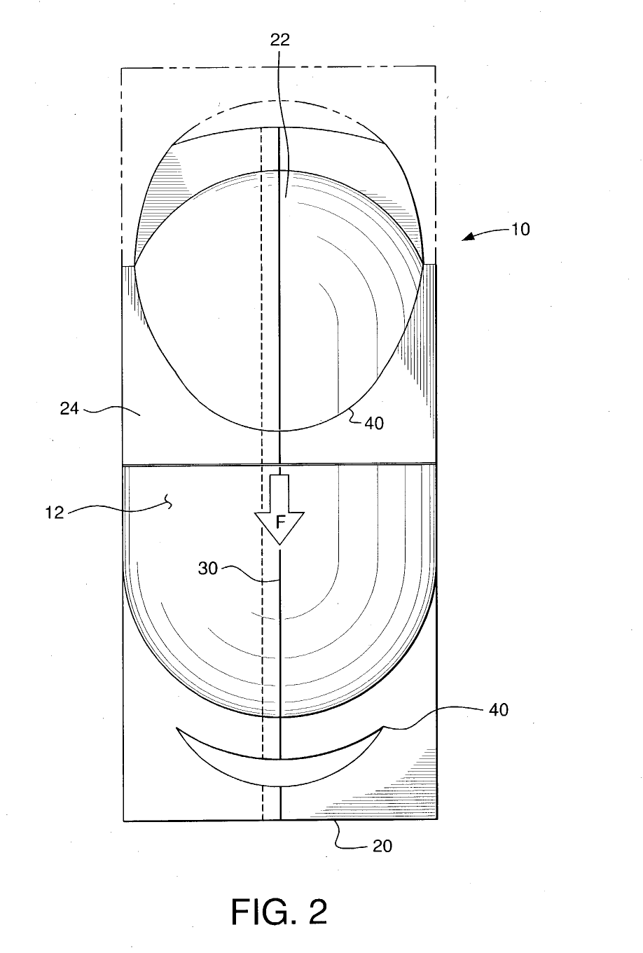

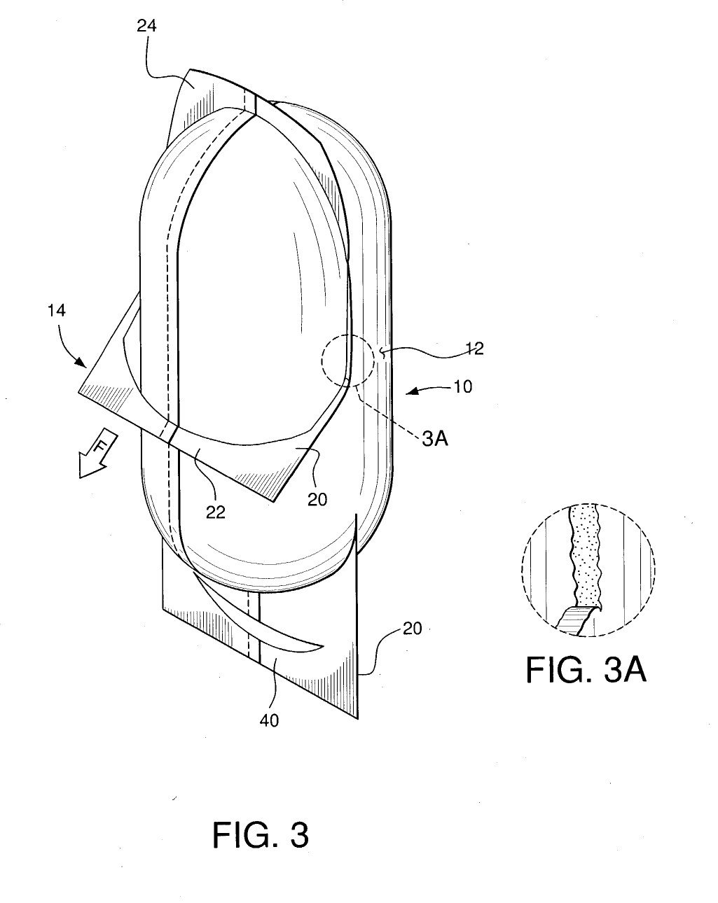

In order to open the package 10, the user grasps the first portion 22 and pulls it in one direction while holding the second portion 24 or the package. FIGS. 2, 3 and 3A illustrate the package 10 in a partially open state. As shown, the first portion 22 is pulled partially away from the second portion 24, taking the bridge sections 26 with it. As the first portion 22 is pulled downward, it tears the sides of the film casing 12 open, thus permitting access to the contents.

To facilitate the tearing, the slotted opening is preferably curved downward at least at one of its ends 42. As shown, the curvature of the slotted opening is preferably oriented so as to direct the tearing of the package downward and to the sides of the package 10. Alternatively or in addition to the angled slot, the fin seal 20 could be weakened at certain positions in the slotted opening 40, such as with a small tear or cut at point 60. This weakening would facilitate the tearing of the package. As shown in FIG. 3, the tearing occurs along opposite sides of the tubular casing 12 of the package 10. Once first portion 22 has been completely pulled down, the second portion 24 will hold the remainder of the casing 12 together. To completely open the package 10, the user would then simply grasp the edges of the torn side and pull open the package 10. Alternatively, the product 50 may be squeezed out through a partially opened section of the package.

Numerous modifications can be made to the package configuration and would be readily understood by persons of ordinary skill in the art in light of the teachings provided herein. For example, the orientation and location of the slotted hole 40 can be modified in many different ways while still providing the novel benefits described herein.

The package 10 of the present invention may be formed using various modified conventional systems, such as a vertical form/fill/seal (VFFS) system. In one embodiment using a VFFS system, flexible packaging material is fed from a roll to a tube former where the web material is formed into an upwardly open tubular casing 12 having overlapping longitudinal edges. These edges are then sealed together longitudinally through the use of heat sealing, adhesives or both, resulting in a lap seal 30.

Next, the lower portion of the tubular casing 12 is laterally sealed, preferably by heat sealing, forming the lower fin seal 20. The tubular casing 12 is filled and then the upper portion is laterally sealed forming the upper fin seal 20. Once filled and sealed the package is severed away from the succeeding package. Lastly, the slotted opening 40 is die cut into one or both of the fin seals 20.

The present invention may be embodied in other specific forms without departing from the spirit or essential attributes thereof and, accordingly, reference should be made to the appended claims, rather than to the foregoing specification, as indicating the scope of the invention.

What is claimed is:

1. A tubular food package comprising a substantially cylindrical-shaped flexible film casing having first and second flattened sealed ends and a longitudinal seal formed from one end to the other, the casing containing a food product, and at least one sealed end having a slotted opening formed in it, the slotted opening having ends which are curved toward the food product and the sides of the casing.

2. The tubular food package of claim 1 wherein the slotted opening is arcuate in shape with the ends of the slot curving toward the sides of the casing.

3. The tubular food package of claim 1 wherein the first and second ends are heat sealed with the edge of the seal closest to the food product being curved in shape.

4. The tubular food package of claim 1 wherein the slotted opening forms a handle.

5. The tubular food package of claim 1 wherein the flexible film casing is formed of multiple plies and is heat sealable.

6. The tubular food package of claim 1 wherein the casing is formed by a vertical form, fill and seal process.

7. The tubular food package of claim 1 wherein the longitudinal seal is a lap seal.

8. The tubular food package of claim 1 wherein the flexible film casing is made from heat-sealable laminate film material including polyethylene, oriented nylon and polypropylene.

9. The tubular food package of claim 1 wherein the flexible film casing is made from heat-sealable laminate film material including polypropylene, oriented polyethylene, and a barrier layer of polyvinyl chloride.

10. The tubular food package of claim 1 wherein the flexible film casing has a thickness of between approximately 2 and 3 microns.

11. A method of making a chub package comprising the steps of:
providing a flexible film sheet;
overlapping two side edges of the film sheet to form a tubular casing;
sealing the overlapping ends;
heat sealing a first end of the tubular casing to form a flattened sealed end;
filling the tubular casing partially with a food product;
heat sealing a second end of the tubular casing to form a flattened sealed end; and
forming a slotted hole in at least one flattened sealed end.

12. The process of claim 11 wherein the slotted hole is curved toward the food product and the sides of the casing.

13. The process of claim 11 wherein the step of heat sealing a second end involves the step of minimizing trapped air between the casing and the food product.

14. The process of claim 11 wherein the step of heat sealing a second end involves the step of minimizing trapped air involves forming the heat seal so as to conform generally to the shape of the food product adjacent to the seal.

15. A process for opening a chub package comprising the steps of:
providing a chub package having first and second heat sealed ends;
grasping an upper portion of one sealed end with one hand;
grasping a lower portion of the same sealed end with the other hand; and
pulling the upper portion away from the lower portion.

16. A tubular food package comprising a substantially cylindrical-shaped flexible film casing having first and second flattened sealed ends and a longitudinal seal formed from one end to the other, the casing containing a food product, and at least one sealed end having first and second tearing points formed in the sealed ends and positioned to cause the end seal to tear towards the food product and the sides of the package.
